(19) United States
(12) Patent Application Publication
(10) Pub. No.: US 2015/0323821 A1
(43) Pub. Date: Nov. 12, 2015

(54) DISPLAY PANEL

(71) Applicant: InnoLux Corporation, Miao-Li County (TW)

(72) Inventors: Shih-Hsiung WU, Miao-Li County (TW); Jui-Chu LAI, Miao-Li County (TW); Feng-Yu LIN, Miao-Li County (TW); Chien-Hung WU, Miao-Li County (TW)

(21) Appl. No.: 14/678,205

(22) Filed: Apr. 3, 2015

Related U.S. Application Data
(60) Provisional application No. 61/991,254, filed on May 9, 2014.

(30) Foreign Application Priority Data
Jul. 9, 2014 (TW) 103123591

(51) Int. Cl. G02F 1/1339; B32B 3/06; B32B 3/30; G02F 1/1337; B32B 7/04

(52) U.S. Cl. CPC G02F 1/1339; G02F 1/1337; G02F 1/13392; B32B 7/04; B32B 3/30; B32B 3/06; G02F 2001/13398; B32B 2457/202

(57) ABSTRACT

A display panel is disclosed, which comprises: a first substrate; a second substrate opposite to the first substrate and comprising a display region and a border region; a sealant disposed between the first substrate and the second substrate and surrounding the display region; and plural protrusions disposed on the border region and respectively has a top surface facing to the first substrate, wherein the sealant has a central dummy line along a longitude direction thereof, and the plurality of protrusions disposed on a region which is defined by peripheries extending from the central dummy line toward two opposite direction substantially vertical to the central dummy line within a distance ranging from 0 μm to 200 μm, wherein on a unit area of the region, a sum of areas of the top surfaces of the plurality of protrusions is 1% to 5% of the unit area.

### CROSS REFERENCE TO RELATED APPLICATION

This application claims the benefits of the Taiwan Patent Application Serial Number 103123591, filed on Jul. 9, 2014, the subject matter of which is incorporated herein by reference.

This application also claims the benefit of filing date of U.S. Provisional Application Ser. No. 61/991,254, entitled “Free shaped display” filed May 9, 2014 under 35 USC §119(e)(1).

### BACKGROUND OF THE INVENTION

1. Field of the Invention

The present invention relates to a display panel and, more particularly to a display panel with protrusions disposed on a substrate to accomplish the purpose of narrowing a border width.

2. Description of Related Art

In recent years, all the display devices are developed toward having small volume, thin thickness and light weight as the display techniques progresses. A liquid crystal display (LCD) device is a flat panel display device with a thin thickness, so a conventional cathode ray tube (CRT) display is gradually replaced by the LCD. Especially, the LCD can be applied to various fields. For example, the daily used devices such as cell phones, notebooks, video cameras, cameras, music players, navigation devices, and televisions are equipped with liquid crystal display (LCD) panels. Herein, brightness, contrast, colors, viewing angles and so on are the main factors related to the quality of the LCD devices.

As the developments of the LCD devices, the main stream or developing LCD panels can be divided into: twisted nematic (TN) mode, vertical alignment (VA) mode, and in-plane switching (IPS) mode. Currently, all kinds the aforementioned LCD panels are developed to have narrowed border regions and maximum display regions.

In the conventional structure of the LCD panels, alignment layers are disposed to facilitate tilts of liquid crystal molecules to achieve the purpose of showing bright states and dark states. However, for the purpose of narrowing the border regions, sometimes, the alignment layers may overlap with sealants, which cause the sealants shrink, float or break, resulting in the yield rate of the display panels reduced.

Therefore, it is desirable to provide a display panel with a narrowed border region and without the aforementioned problem.

### SUMMARY OF THE INVENTION

An object of the present invention is to provide a display panel, which can solve the problem that a sealant unit may shrink, float or break when it overlaps with an alignment layer.

To achieve the object, the display panel of the present invention comprises: a first substrate; a second substrate opposite to the first substrate and comprising a display region and a border region; a sealant unit disposed between the first substrate and the second substrate and surrounding the display region; a plurality of protrusions disposed on the border region and each of the plurality of protrusions respectively having a top surface facing to the first substrate, wherein the sealant unit has a central dummy line along a longitude direction thereof, and the plurality of protrusions are disposed on a region which is defined by peripheries extending from the central dummy line toward two opposite direction substantially vertical to the central dummy line within a distance ranging from 0 μm to 200 μm, wherein on an unit area of the region, a sum of areas of the top surfaces of the plurality of protrusions is 1% to 5% of the unit area.

In the display panel of the present invention, preferably, the plurality of protrusions are disposed on a region which is defined by peripheries extending from the central dummy line toward two opposite direction substantially vertical to the central dummy line within a distance ranging from 50 μm to 200 μm. In addition, the unit area is in a range from 2,500 μm² to 40,000 μm². Furthermore, a width of the sealant unit is in a range from 800 μm to 1000 μm. Moreover, the sealant unit covers the plurality of protrusions.

In the display panel of the present invention, the sealant unit may comprise a plurality of spacing units, an alignment layer may be further disposed on the display region of the second substrate, and heights of the plurality of protrusions are larger than a thickness of the alignment layer and smaller than diameters of the plurality of spacing units. Herein, the thickness of the alignment layer may be in a range from 0.04 μm to 0.25 μm; and the diameters of the plurality of spacing units may be respectively in a range from 2 μm to 7 μm. Hence, the heights of the plurality of protrusions preferably are respectively in a range from 0.2 μm to 7 μm.

In addition, in the display panel of the present invention, a gap between two adjacent protrusions is larger than the diameters of the plurality of spacing units. Preferably, a gap between two adjacent protrusions is 2 μm or more.

Herein, each of the plurality of spacing units may be respectively a sphere spacing unit or a columnar spacing unit. In the case that the plurality of spacing units are columnar spacing units, the diameter thereof refers to a diameter of a cross-section of the columnar spacing unit.

Furthermore, in the display panel of the present invention, one of the first substrate and the second substrate is a substrate with thin film transistor (TFT) units formed thereon, and the other one is another substrate with color filter (CF) units formed thereon. Alternatively, one of the first substrate and the second substrate is a substrate with both TFT units and CF units formed thereon.

In addition, in the display panel of the present invention, the material for the plurality of protrusions is not particularly limited, and can be an insulating material or a resin.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a display panel according to one preferred embodiment of the present invention;

FIG. 2 is a cross-sectional view of a display panel according to one preferred embodiment of the present invention;

FIG. 3 is a partial view of a display panel according to one preferred embodiment of the present invention;

FIG. 4A is a partial cross-sectional view of a display panel according to one preferred embodiment of the present invention;

FIGS. 4B and 4C are cross-sectional views showing protrusions of a display panel according to one preferred embodiment of the present invention;

FIG. 5 is a partial cross-sectional view of a display panel according to one preferred embodiment of the present invention;

FIG. 6 is a perspective view showing partial display panel according to another preferred embodiment of the present invention; and

FIG. 7 is a perspective view of a display panel according to further another preferred embodiment of the present invention.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

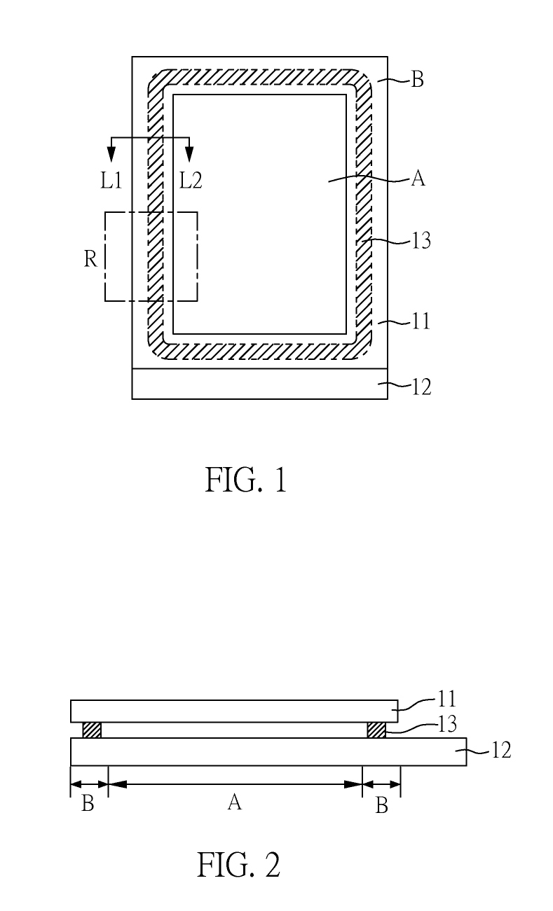

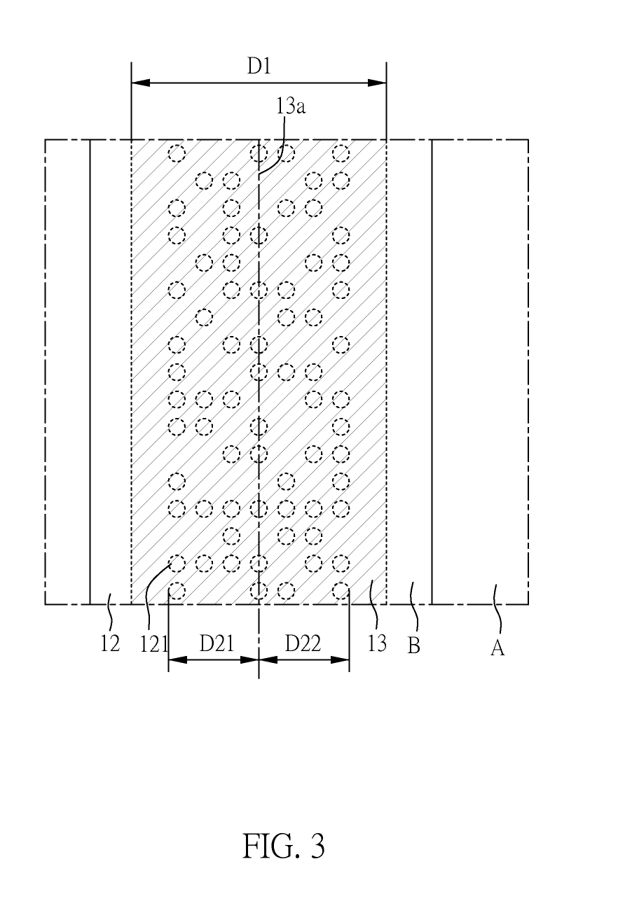

FIGS. 1 and 2 are respectively a top view and a cross-sectional view of a display panel according to one preferred embodiment of the present invention. As shown in FIG. 2, the method for manufacturing the display panel of the present embodiment comprises: providing a first substrate 11 and a second substrate 12; and assembling the first substrate 11 and the second substrate 12 with a sealant unit 13. Hence, the obtained display panel of the present embodiment comprises: a first substrate 11; a second substrate 12 opposite to the first substrate 11 and comprising a display region A and a border region B; and a sealant unit 13 disposed between the first substrate 11 and the second substrate 12 and surrounding the display region A of the second substrate 12.

In the present embodiment, a space between the first substrate 11 and the second substrate 12 is filled with liquid crystal molecules, so that the display panel of the present embodiment is a liquid crystal display (LCD) panel. Herein, one of the first substrate 11 and the second substrate 12 may be a TFT substrate with TFT units formed thereon, and the other one is a CF substrate with CF units and a black matrix (BM) formed thereon.

Alternatively, one of the first substrate 11 and the second substrate 12 is a COA substrate with both TFT units and CF units formed thereon, and the other one is a substrate with the BM formed thereon. In addition, in other embodiment of the present invention, organic light emitting diode (OLED) units may be disposed on the second substrate 12 to obtain an OLED display panel. The aforementioned first substrate 11 and the second substrate 12 may have structures generally used in the LCD panel or the OLED display panel in the art, and therefore the detail structures thereof are not illustrated herein.

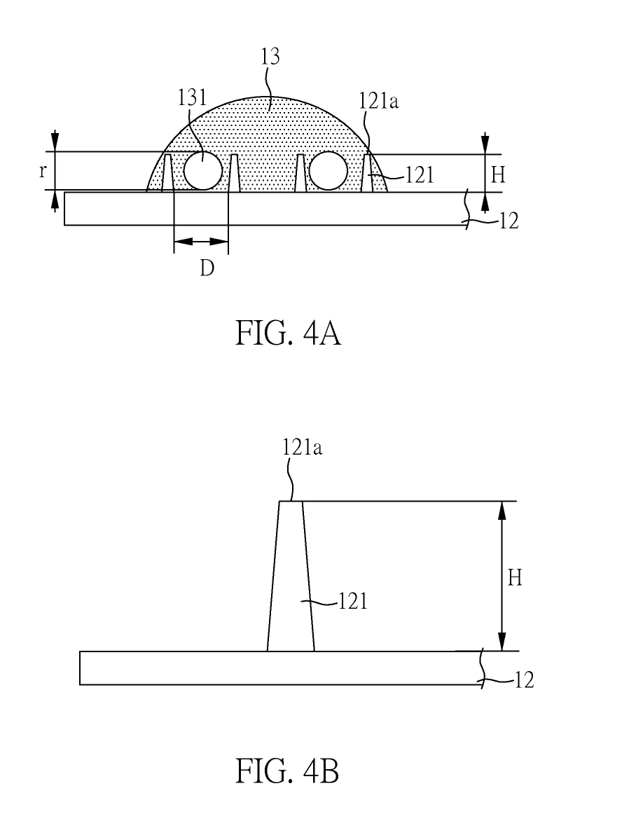

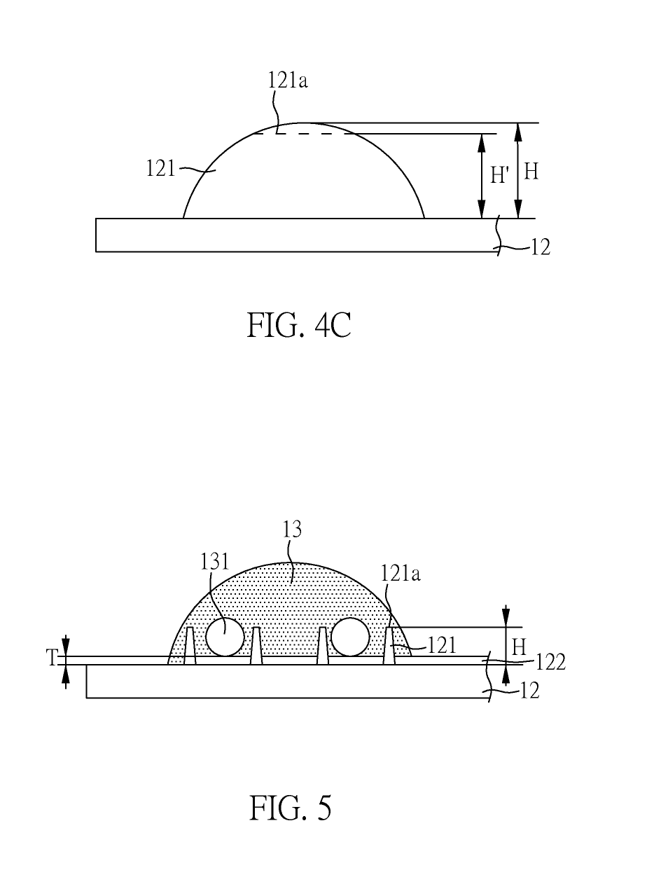

FIG. 3 is a perspective view showing the region R indicated in FIG. 1 of the display panel of the present embodiment, and FIG. 4A is a cross-sectional view along the L1-L2 line indicated in FIG. 1. As shown in FIGS. 3 and 4A, the display panel of the present embodiment further comprises: a plurality of protrusions 121 disposed on the border region B of the second substrate 12 and respectively having a top surface 121a facing to the first substrate (not shown in the figure). During the process for manufacturing the display panel of the present embodiment, a sealant unit 13 is applied onto the second substrate 12 along a central dummy line 13a. Herein, the plurality of protrusions 121 are disposed on a region which is defined by peripheries extending from the central dummy line 13a toward two opposite direction substantially vertical to the central dummy line 13a within a distance ranging 0 μm to 200 μm, and a width D1 of the sealant unit 13 is in a range from 800 μm to 1000 μm. In addition, based on a unit area of the aforementioned region disposed with the plurality of protrusions 121, a sum of areas of the top surfaces 121a of the plurality of protrusions 121 is 1% to 5% of the unit area. After coating the sealant unit 13 and assembling the first substrate 11 and the second substrate 12, the display panel of the present embodiment can be obtained. In the case that the plurality of protrusions 121 are disposed on the substrate and the sum of the areas of the top surfaces 121a of the plurality of protrusions 121 is 1% to 5% of the unit area, the problem that the sealant unit 13 may shrink, float or break can be prevented.

As shown in FIG. 3, in the display panel of the present embodiment, the sealant unit 13 has a central dummy line 13a along a longitude direction thereof, and the plurality of protrusions 121 are disposed on a region apart from the central dummy line 13a 0 μm to 200 μm. More specifically, the plurality of protrusions 121 are disposed on a region which is defined by peripheries extending from the central dummy line 13a toward two opposite direction substantially vertical to the central dummy line 13a within distances D21, D22 respectively being between 0 μm and 200 μm. Preferably, the plurality of protrusions 121 are disposed on a region which is defined by peripheries extending from the central dummy line 13a of the sealant unit 13 toward two opposite direction substantially vertical to the central dummy line 13a within distances D21, D22 respectively being between 50 μm and 200 μm. More preferably, the plurality of protrusions 121 are disposed on a region which is defined by peripheries extending from the central dummy line 13a of the sealant unit 13 toward two opposite direction substantially vertical to the central dummy line 13a within distances D21, D22 respectively being between 130 μm and 180 μm. Most preferably, the plurality of protrusions 121 are disposed on a region which is defined by peripheries extending from the central dummy line 13a of the sealant unit 13 toward two opposite direction substantially vertical to the central dummy line 13a within distances D21, D22 respectively being about 150 μm.

In addition, as shown in FIGS. 3 and 4A, in the display panel of the present embodiment, based on a unit area of the aforementioned region disposed with the plurality of protrusions 121, a sum of areas of the top surfaces 121a of the plurality of protrusions 121 is 1% to 5% of the unit area. Herein, the unit area is in a range from 2,500 μm² (50 μm×50 μm) to 40,000 μm² (200 μm×200 μm). In the present embodiment, a cross-section of the protrusion 121 is a trapezoid. As shown in FIG. 4B which is an enlarge view of the protrusion 121 shown in FIG. 4A, a cross-section of the protrusion 121 is a trapezoid. However, the present invention is not limited thereto, and the cross-section of the protrusion 121 can have other shapes, such as a rectangle and a square, as long as a sum of areas of the top surfaces 121a of the plurality of protrusions 121 satisfies the aforementioned range. In addition, FIG. 4C is a cross-sectional view showing a protrusion 121 according another preferred embodiment of the present invention, wherein a cross-sectional of the protrusion 121 has an arc sharp. In this case, when the protrusion 121 has a height H, the area of the top surfaces 121a is an area of a transversal surface at 90% height H (i.e. height H′) of the protrusion 121.

In the present embodiment, as shown in FIG. 4A, the sealant unit 13 may further comprise a plurality of spacing units 131, which can keep the gap between the first substrate 11 and the second substrate 12 (as shown in FIG. 1). Herein, each the plurality of spacing units 131 may respectively a sphere spacing unit or a columnar spacing unit. The plurality of spacing units 131 being sphere spacing units may have a diameter r. In other case that the plurality of spacing units 131 are columnar spacing units, the diameter thereof indicates a cross-section of the columnar spacing unit.

As shown in FIGS. 3 and 4A, in the display panel of the present embodiment, a gap D between two adjacent protrusions 121 is larger than the diameters r of the plurality of spacing units 131. The diameters r of the plurality of spacing units 131 generally used in the art are respectively in a range from 2 μm to 7 μm. Hence, in the present embodiment, the gap D between two adjacent protrusions 121 can be adjusted according to the diameters r of the used spacing units 131, and may be 2 μm or more.

Furthermore, in the display panel of the present embodiment, the heights H of the plurality of protrusions 121 are smaller than the diameters r of the plurality of spacing units 131. The diameters r of the plurality of spacing units 131 generally used in the art are respectively in a range from 2 μm to 7 μm. Hence, in the present embodiment, the heights H of the plurality of protrusions 121 are less than the range from 2 μm to 7 μm, which can be adjusted according to the diameters r of the used spacing units 131.

When the display panel of the present embodiment is a LCD panel (especially, a vertical alignment LCD panel), an alignment layer 122 is further disposed on the second substrate 12, as shown in FIG. 5. In an ideal case, the alignment layer 122 is disposed on the display region A indicated in FIG. 1. However, for the purpose of maximizing the display region and narrowing the border region B, sometimes, the alignment layer 122 may be formed on the border region B, as shown in FIG. 5. If the sealant unit 13 is formed on the alignment layer 122 or partially overlaps with the alignment layer 122, the sealant unit 13 may shrink, float or break, resulting in a yield rate of the display panel reduced. In the present embodiment, as shown in FIG. 5, the plurality of protrusions 121 disposed on the border region B of the second substrate 11 can fix the position of the sealant unit 13 on the border region B. Therefore, the problem that the sealant unit may shrink, float or break when it overlaps with an alignment layer can be solved, and the limitation that the sealant unit 13 cannot overlap with the alignment layer 122 can be eliminated to achieve the purpose of narrowing the border region and enhancing the utility of the substrate.

In the present embodiment, as shown in FIG. 5, in order to achieve the purpose that the sealant unit 13 may shrink, float or break when it covers the alignment layer 122, the heights H of the plurality of protrusions 121 have to be larger than a thickness T of the alignment layer 122. The thickness T of the alignment layer 122 is generally in a range from 0.04 μm to 0.25 μm, so the heights H of the plurality of protrusions 121 have to be larger than the range from 0.04 μm to 0.25 μm, which can be adjusted according to the thickness T of the used alignment layer 122.

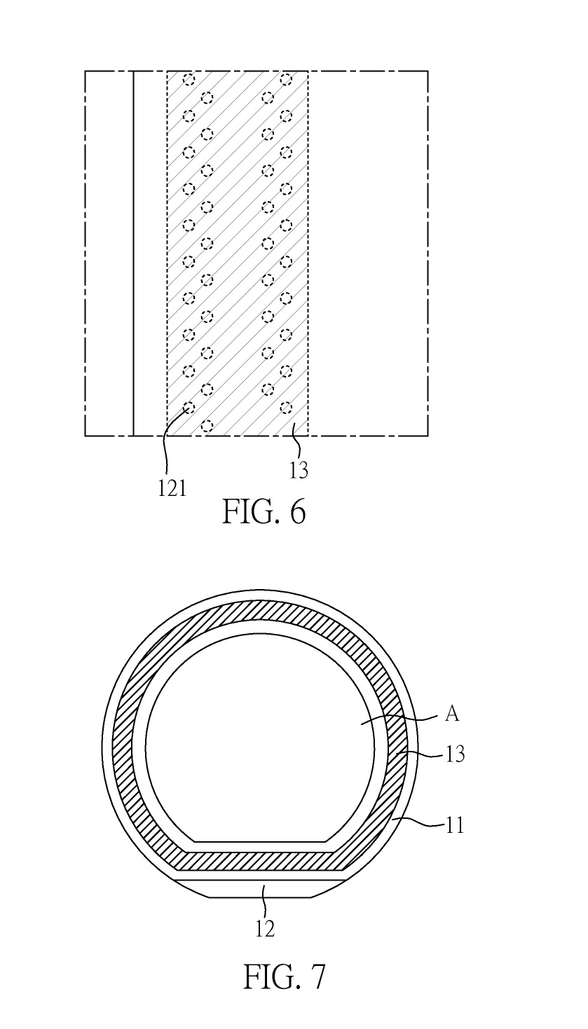

FIG. 6 is a perspective view showing partial display panel according to another embodiment of the present invention. The structure of the present embodiment is similar to that of the aforementioned embodiment, except that the plurality of protrusions 121 in the display panel of the aforementioned embodiment are arranged in an irregular manner (as shown in FIG. 3), but the plurality of protrusions 121 in the present embodiment are arranged in a regular manner (as shown in FIG. 6).

FIG. 7 is a perspective view of a display panel according to further another embodiment of the present invention. The structure of the present embodiment is similar to that of the aforementioned embodiment, except that the display panel of the aforementioned embodiments is a rectangular display panel, but the display panel of the present embodiment is a display panel having an arc edge.

In the display panels of all the aforementioned embodiments, the formation of the plurality of protrusions is not particularly limited, and can be formed together with an insulating layer by using an insulating material, together with color filter units by using a resin, or together with photo spacers by using a photosensitive material. However, the present invention is not limited thereto.

Furthermore, the display panels provided by the aforementioned embodiments of the present invention can be applied to any electronic device with a screen, such as a mobile phone, a notebook, a camera, a video camera, a music player, a navigation system, or a television.

Although the present invention has been explained in relation to its preferred embodiment, it is to be understood that many other possible modifications and variations can be made without departing from the spirit and scope of the invention as hereinafter claimed.

What is claimed is:

1. A display panel, comprising:
a first substrate;
a second substrate opposite to the first substrate and comprising a display region and a border region;
a sealant unit disposed between the first substrate and the second substrate and surrounding the display region; and
a plurality of protrusions disposed on the border region and each of the plurality of protrusions respectively having a top surface facing to the first substrate,
wherein the sealant unit has a central dummy line along a longitude direction thereof, and the plurality of protrusions are disposed on a region which is defined by peripheries extending from the central dummy line toward two opposite direction substantially vertical to the central dummy line within a distance ranging from 0 μm to 200 μm,
wherein on a unit area of the region, a sum of areas of the top surfaces of the plurality of protrusions is 1% to 5% of the unit area.

2. The display panel as claimed in claim 1, wherein the plurality of protrusions are disposed on a region which is defined by peripheries extending from the central dummy line toward two opposite direction substantially vertical to the central dummy line within a distance ranging from 50 μm to 200 μm.

3. The display panel as claimed in claim 1, wherein the unit area is in a range from 2,500 μm² to 40,000 μm².

4. The display panel as claimed in claim 1, wherein a width of the sealant unit is in a range from 800 μm to 1000 μm.

5. The display panel as claimed in claim 1, wherein the sealant unit comprises a plurality of spacing units, an alignment layer is further disposed on the display region of the second substrate, and heights of the plurality of protrusions are larger than a thickness of the alignment layer and smaller than diameters of the plurality of spacing units.

6. The display panel as claimed in claim 5, wherein each of the plurality of spacing units are respectively a sphere spacing unit or a columnar spacing unit.

7. The display panel as claimed in claim 5, wherein the thickness of the alignment layer is in a range from 0.04 μm to 0.25 μm.

8. The display panel as claimed in claim 5, wherein the diameters of the plurality of spacing units are respectively in a range from 2 μm to 7 μm.

9. The display panel as claimed in claim 5, wherein a gap between two adjacent protrusions is larger than the diameters of the plurality of spacing units.

10. The display panel as claimed in claim 1, wherein the plurality of protrusions are made of an insulating material or a resin.
